(19) United States
(12) Patent Application Publication
(10) Pub. No.: US 2008/0082801 A1
(43) Pub. Date: Apr. 3, 2008

(54) APPARATUS AND METHOD FOR TRACING INSTRUCTIONS WITH SIMPLIFIED INSTRUCTION STATE DESCRIPTORS

(75) Inventors: Ernest L. EDGAR, Larkspur, CO (US); Radhika Thekkath, Palo Alto, CA (US)

Correspondence Address: COOLEY GODWARD KRONISH LLP;ATTN: Patent Group, Suite 1100, 777 - 6th Street, NW, Washington, DC, 20001, US

(73) Assignee: MIPS Technologies, Inc., Mountain View, CA (US)

(21) Appl. No.: 11/537,574

(22) Filed: Sep. 29, 2006

(51) Int. Cl. G06F 9/44

(52) U.S. Cl. 712/227

(57) ABSTRACT

A method of tracing processor instructions includes characterizing processor state changes in accordance with simplified instruction state descriptors. The simplified instruction state descriptors are then traced with processor instructions, but processor data is not traced.

### BRIEF DESCRIPTION OF THE INVENTION

This invention relates generally to digital data processors. More particularly, this invention relates to a technique for tracing digital data processor instructions with simplified instruction state descriptors.

### BACKGROUND OF THE INVENTION

There are many known techniques for tracing information from a digital data processor. These techniques typically include tracing information in the form of instructions and data. The resultant traced information may then be used for debugging purposes.

Existing information tracing techniques are relatively complex, requiring a considerable amount of circuitry to support tracing operations. Such an approach is not practical for some processors. In particular, some processors may be configured for relatively light computational applications. In such a context, traditional tracing approaches are not practical because the amount of circuitry required to support tracing operations is too expensive.

In view of the foregoing, it would be desirable to provide improved techniques for tracing processor information from computationally simplified processors.

### SUMMARY OF THE INVENTION

The invention includes a method of tracing processor instructions by characterizing processor state changes in accordance with simplified instruction state descriptors. The simplified instruction state descriptors are then traced with processor instructions, but data is not traced.

The invention also includes a computer readable storage medium with executable instructions to characterize a circuit. The executable instructions include instructions to characterize processor state changes in accordance with simplified instruction state descriptors. The simplified instruction state descriptors are then delivered.

The invention also includes a processor with circuitry to characterize processor state changes in accordance with simplified instruction state descriptors. A processor port routes the simplified instruction state descriptors.

The invention also includes a system with a processor with circuitry to characterize processor state changes in accordance with simplified instruction state descriptors. A processor port routes simplified instruction state descriptors. An instruction trace control block routes the simplified instruction state descriptors to a memory.

The invention also includes a memory and an instruction trace control block to write simplified instruction state descriptors to the memory and selectively deliver program counter information with sub-sets of simplified instruction state descriptors.

### BRIEF DESCRIPTION OF THE FIGURES

The invention is more fully appreciated in connection with the following detailed description taken in conjunction with the accompanying drawings, in which:

FIG. 1 illustrates processing operations associated with an embodiment of the invention.

FIG. 2 illustrates a debug system configured in accordance with an embodiment of the invention.

FIG. 3 illustrates a system configured in accordance with an embodiment of the invention. Like reference numerals refer to corresponding parts throughout the several views of the drawings.

### DETAILED DESCRIPTION OF THE INVENTION

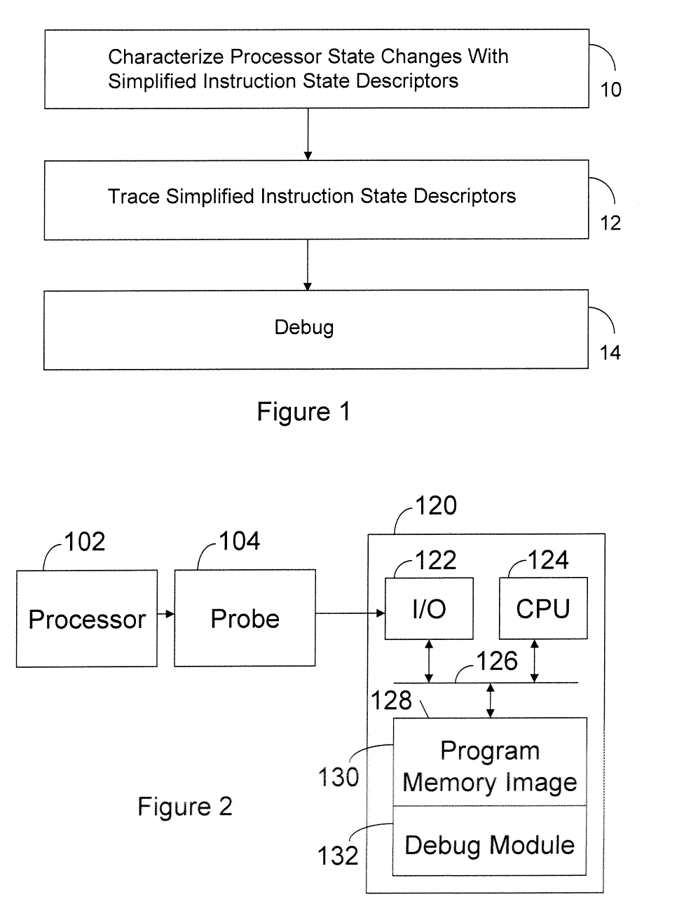

FIG. 1 illustrates processing operations associated with an embodiment of the invention. Processor state changes are characterized with simplified instruction state descriptors 10. The simplified instruction state descriptors operate to reduce the amount of traced information. Instead of cycle-by-cycle state information, the invention only provides information in response to state changes. The traced information includes simplified instruction state descriptors and periodic program counter information.

The next processing operation of FIG. 1 is to trace the simplified instruction state descriptors 12. Sub-sets of the simplified instruction state descriptors may be accompanied by program counter information, as discussed below. The trace stream does not include data, which is typical in prior art tracing mechanisms. The simplified instruction state descriptor allow for reconstruction of the instruction sequence. The periodically traced program counter information is used to track instruction branches.

The traced information is then debugged 14. This is typically accomplished using an image of the program executed by the processor. A debug module operating with the program image may be used to implement this operation. The debug module links the simplified instruction set descriptors to instructions in the program image. Branch instructions are tracked with the periodically traced program counter differential information, as discussed below.

FIG. 2 illustrates a system configured in accordance with an embodiment of the invention. The system includes a processor 102 to generate trace information, including the simplified instruction state descriptors and periodic program counter differential values. A probe 104 routes the trace information to a computer 120. In particular, the trace information is routed to an input device of the computer 120. A set of input/output devices 122 may include a port to receive the trace information. The set of input/output devices 122 may also include other standard input/output devices, such as a keyboard, mouse, display, printer and the like. A central processing unit 124 is connected to the input/output devices 122 via a bus 126. A memory 128 is also connected to the bus 126. The memory 128 stores a program memory image 130 corresponding to the program being executed by the processor 102. A debug module 132 includes executable instructions to process the trace information and the program memory image 130 to perform debugging operations.

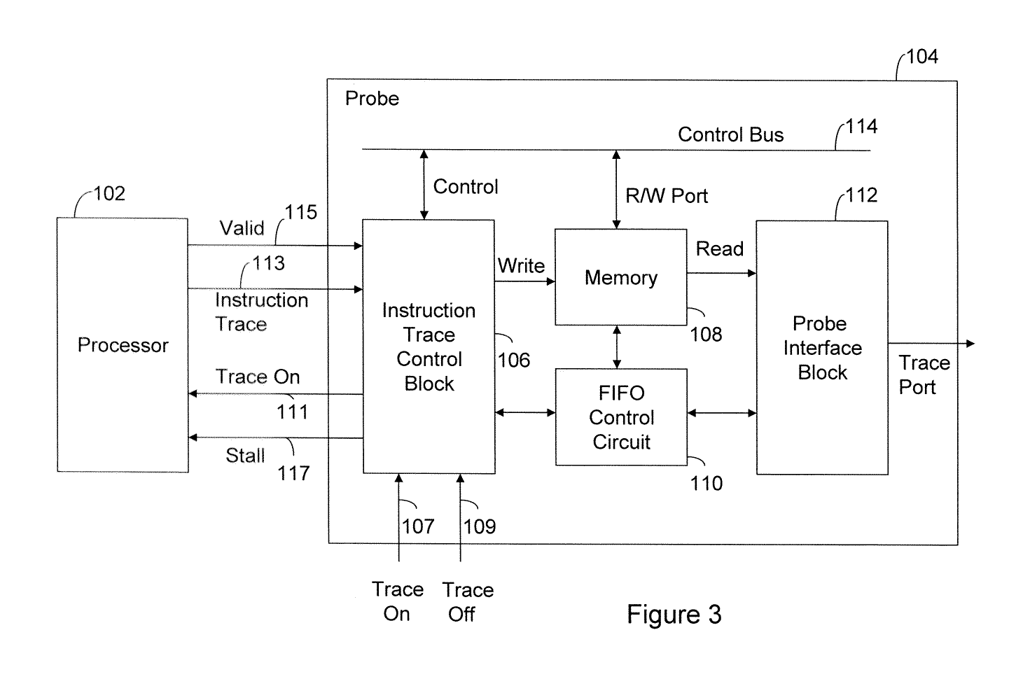

FIG. 3 is a more detailed characterization of a processor 102 and probe 104 utilized in accordance with an embodiment of the invention. The processor 102 is configured to generate simplified instruction state descriptors, as discussed below. In one embodiment, the probe 104 includes an instruction trace control block 106. The instruction trace control block 106 receives a trace on command at node 107 and a trace off command at node 109. The instruction trace control block 106 routes a trace on command to the processor 102 via node 111. The instruction trace control block 106 receives an instruction trace of simplified instruction state descriptors via node 113. During cycles in which an instruction is not processed, a non-valid signal is sent from the processor 102 to the instruction trace control block 106 via node 115. This reduces the amount of trace information that needs to be processed.

The probe 104 may include a memory 108 to store traced information. Alternately, an external memory may be used in conjunction with the probe 104. In one embodiment, the memory 108 is configured as a FIFO to store traced information. The instruction trace control block 106 is configured to identify when the FIFO is close to being full and in response to this condition, generates a stall signal applied to node 117 to prevent the processor from generating additional trace information that would otherwise overflow the FIFO. A FIFO control circuit 110 is connected to the memory 108 and the instruction trace control block 106 to coordinate this operation.

An optional probe interface block 112 provides an interface between the memory 108 and an external trace port, which delivers trace information to the computer 120. The probe 104 may also include a control bus 114 to apply control signals to the instruction trace control block and to coordinate memory control.

Thus, the invention provides a compressed and minimal set of information to reconstruct a simple instruction trace from an execution stream. The simple mechanism enables a small, efficient tracing methodology for relatively small processor cores.

A trace methodology is often defined by its inputs and outputs. Hence, an embodiment of the invention is described by the inputs to the core tracing logic and by the trace output format from the core. The execution flow of the program is traced at the end of the execution path.

The invention is disclosed in connection with a processor compatible with the family of processors sold by MIPS Technologies, Inc., Mountain View, Calif. The disclosure of the invention in this context is by way of example; naturally, the techniques of the invention are applicable to any number of chip architectures.

Attention initially turns to the trace inputs. One embodiment of the invention uses an In_TraceOn signal. When this signal is on, trace information is received from the core. The information is received when the signal is activated; that is, for the first traced instruction, a full PC value is output. When off, it cannot be assumed that legal trace words are available at the core interface.

An embodiment of the invention also uses an In_Stall signal. The In_Stall signal stalls the processor to avoid buffer (FIFO) overflow that can lose trace information. When off, a buffer overflow will simply throw away trace data and start over again. When on, the processor is signaled from the tracing logic to stall until the buffer is sufficiently drained and then the pipeline is restarted.

Depending on the core pipeline and the ease with which the pipe can be stalled, the trace control block needs to know the latency between the assertion of the In_Stall signal and the maximum number of cycles before the pipe can be halted. This information is then used to determine how many empty trace FIFO entries are needed to store potential trace information after the stall is asserted and the Out_Valid signal will be de-asserted.

For a given core implementation, the maximum pipeline stall latency is known and this will be used by the Instruction Trace Control Block (ITCB) 106 for its worst case calculations on FIFO space requirements. Note that if tracing is turned on, stalls are enabled to ensure no lost trace data, and the code being run has a particularly large number of unpredictable jumps, then for a given FIFO size, it is possible to make the core stall quite often. This will affect the use of the processor and the performance that one would see on the core when running under these conditions. If it is anticipated that tracing will be enabled and stalls will be enabled for full traces as the default configuration, then it is essential to take typical code that will run under these situations and characterize the number of bits of trace that will be needed for say 100 instructions and correlate that back to both the size of the FIFO in the ITCB 106 as well the expected rate at which this FIFO will be cleared in order to prevent an excessive amount of stalling.

With respect to trace outputs, stall cycles in the pipe are ignored by the tracing logic and are not traced. This is indicated by a valid signal (Out_Valid) that is turned off when no valid instruction is being traced. When the valid signal is on, instructions are traced out as described below. The traced instruction program counter (PC) value is a virtual address. In the output format, every sequentially executed instruction is traced as bit 0. Every instruction that is not sequential to the previous one is traced as either a 10 or an 11. This implies that the target instruction of a branch or jump is traced this way, not the actual branch or jump instruction. A 10 instruction implies a taken branch for a conditional branch instruction whose condition is unpredictable statically, but whose branch target can be computed statically and hence the new PC does not need to be traced out. Note that if this branch was not taken, it would have been indicated by a 0 bit that is sequential flow.

A 11 instruction implies a taken branch for an indirect jump-like instruction whose branch target could not be computed statically and hence the taken branch address is now given in the trace. This includes, for example, instructions like jr and jalr (associated with the MIPS instruction set) and interrupts:
11 00—followed by 8 bits of 1-bit shifted offset from the last PC. The bit assignments of this format on the instruction trace node 113 between the core tracing logic and the ITCB 106 is:
[3:0]=4′b0011
[11:4]=PCdelta[8:1]
11 01—followed by 16 bits of 1-bit shifted offset from the last PC. The bit assignments of this format on the instruction trace node 113 between the core tracing logic and the ITCB is:
[3:0]=4′b1011
[19:4]=PCdelta[16:1]
11 10—followed by 31 of the most significant bits of the PC value, followed by a bit (NCC) that indicates no code compression. Note that for a MIPS32 or MIPS64 instruction, NCC is 1, and for MIPS16e instruction NCC is 0, this trace record will appear at all transition points between MIPS32/MIPS64 and MIPS16e instruction execution. This form is also a special case of the 11 format and it is used when the instruction is not a branch or jump, but nevertheless the full PC value needs to be reconstructed. This is used for synchronization purposes, similar to the Sync in PDtrace. A preset sync period of 256 instructions is counted down and when an internal counter runs through all the values, this format is used. The bit assignments of this format on the instruction trace node 113 between the core tracing logic and the ITCB is:
[3:0]=4′b01 11
[34:4]=PC[31:1]
[36]=NCC
11 11—Used to indicate trace resumption after a discontinuity occurs. The next format is a 1110 that sends a full PC value. A discontinuity might happen due to various reasons, for example, an internal buffer overflow and at trace-on/trace-off trigger action. The ITCB 106 is responsible for accepting trace signals from the processor 102, formatting them, and storing them into an on-chip memory 108 organized as a circular buffer. The Probe Interface Block (PIB) 112 is capable of emptying the memory 108 and outputs the memory contents through a narrow off-chip trace port.

In one embodiment, the instruction trace node 113 consists of 36 data signals plus a valid signal. The 36 data signals encode information about what the processor is doing in each clock cycle. A valid signal on node 115 indicates that the processor 102 is executing an instruction in this cycle and therefore the 36 data signals carry valid execution information. The data bus 113 is encoded as shown in Table I. Note that all the non-defined upper bits of the bus are zeroes.

TABLE I
Data Bus Encoding

| Valid | Data (LSBa) | Description |
|---|---|---|
| 0 | x | No instructions executed in this cycle |
| 1 | 0 | Sequential instruction executed |
| 1 | 01 | Branch executed, destination predictable from |
| | | code |
| 1 | <8>0011 | Discontinuous instruction executed; PC offset |
| | | is small (e.g., 8 bit signed offset) |
| 1 | <16>1011 | Discontinuous instruction executed; PC offset |
| | | is large (e.g., 16 bit signed offset) |
| 1 | <NCC><31>0111 | Discontinuous instruction or synchronization |
| | | record, No Code Compression (NCC) bit |
| | | included as well as 31 MSBs of the PC value |
| 1 | 1111 | Internal overflow |

Thus, when the valid signal is low (0), an instruction is not executed and the PC value is unchanged. When the valid signal is high (1) and the data signal is 0, a sequential instruction is executed. Thus, this simplified instruction state descriptor results in the PC value being incremented when interpreting the trace information in connection with the program image. The remaining simplified instruction state descriptors allow the PC value to be derived on a differential offset basis.

Thus, the ITCB 106 controls trace using the In_TraceOn signal. When 0, all data appearing on the trace outputs on node 113 is considered invalid. To turn on trace, the ITCB 106 switches In_TraceOn from 0 to 1. A 1011 record represents the first instruction executed thereafter with a full PC indicating the current execution point.

Records from the trace information are inserted into a memory stream exactly as they appear on node 113. Records are concentrated into a continuous stream starting at the LSB. When a trace word is filled, it is written to memory along with some tag bits. Each record consists of a 64-bit word, which comprises 58 message bits and 6 tag bits or header bits that clarify information about the message in that word.

In one embodiment, the ITCB 106 includes a 58-bit shift register to accommodate trace messages. Once 58 or more bits are accumulated, the 58 bits and 6 tag bits are sent to the memory write interface. Messages may span a trace word boundary. In this case, the 6 tag bits indicate the bit number of the first full trace message in the 58-bit data field.

The tag bits are not strictly binary because they serve a secondary purpose of indicating to off-chip trace hardware when a valid trace word translation begins. At least one of the 4 LSB's of the tag is always a 1. The longest trace message is 36 bits, so the starting position indicated by the tag bits is always between 0 and 35.

When trace stops (ON set to zero), any partially filled trace words are written to memory 108. Any unused space above the final message is filled with 1's. The decoder distinguishes 1111 patterns used for fill in this position from an 1111 overflow message by recognizing that it is the last trace word.

These trace words are written to a trace memory that is either on-chip or off-chip. No particular size of SRAM is specified; the size is user selectable based on the application needs and area trade-offs. Each trace word typically stores about 20 to 30 instructions, so a 1 KWord trace memory could store the history of 20 K to 30 K executed instructions

In one embodiment, the ITCB 106 includes a drseg memory interface (control bus 114) to allow the MIPS CPU to set up tracing and read current status. There are two drseg register locations to the ITCB as shown in Table II.

TABLE II
Registers in the ITCB

| drseg | | | | |
|---|---|---|---|---|
| Location | | Defined | | |
| Offset | Register | Bits | Code | Description |
| 0x3FC0 | Control/Status | 0 | ON | Software control of trace collection. 0 disables |
| | | | | all collection and flushes out any partially filled |
| | | | | trace words. |
| | | 1 | EN | Trace enable. This bit may be set by software or |
| | | | | by Trace-on/Trace-off action bits from the |
| | | | | Complex Trigger block. Software writes EN |
| | | | | with the desired initial state of tracing when the |
| | | | | ITCB is first turned on and EN is controlled by |
| | | | | hardware thereafter. EN turning on and off does |
| | | | | not flush partly filled trace words. |
| | | 2 | IO | Inhibit overflow. If set, the CPU is stalled |
| | | | | whenever the trace memory is full. Ignored |
| | | | | unless O/C is also set. |
| | | 3 | O/C | Offchip. 1 enables the PIB (if present) to unload |
| | | | | the trace memory. 0 disables the PIB and would |
| | | | | be used when on-chip storage is desired or if a |
| | | | | PIB is not present. The bit is settable only if the |
| | | | | design supports both on-chip and off-chip |
| | | | | modes. Otherwise it is a read-only bit indicating |
| | | | | which mode is supported. |
| | | 4 | OfClk | Controls the Off-chip clock ratio. When the bit |
| | | | | is set, this implies 1:2, that is the trace clock is |
| | | | | running at 1/2 the core clock, and when the bit is |
| | | | | clear, implies 1:4 ratio, that is the trace clock is |
| | | | | at 1/4 the core clock. |
| 0x3FC8 | Trace write | N:0 | W/Addr | This register is used only if the SRAM is |
| | address | | | supported in the on-chip mode. The current |
| | pointer | | | write pointer is for trace memory. Each |
| | | | | completed trace word is written to memory, then |
| | | | | W/Addr increments. When trace concludes, |
| | | | | W/Addr contains the first address in trace |
| | | | | memory not yet written. |
| | | 31 | W/rap | Trace wrapped. This bit indicates that the entire |
| | | | | trace depth has been written at least once. After |
| | | | | trace concludes, this bit along with W/Addr is |
| | | | | used by software to determine the oldest and |
| | | | | youngest words in the buffer. |

In one embodiment, the off-chip interface consists of a 4-bit data port (TR_DATA) and a trace clock (TR_CLK). TR_CLK can be a Double Data Rate (DDR) clock, that is, both edges are significant. TR_DATA and TR_CLK follow the same timing and have the same output structure as the PDTrace TCB described in MIPS specifications (see, e.g., www.mips.com). The trace clock is the same as the system clock or related to the system clock as either divided or multiplied. The OfClk bit in the Control/Status register is of the form X:Y, where X is the trace clock and Y is the core clock. The Trace clock is always ½ of the trace port data rate, hence the “full speed” ITCB outputs data at the CPU core clock rate but the trace clock is half that, hence the 1:2 OfClk value is the full speed, and the 1:4 OfClk ratio is half-speed.

When a 64-bit trace word is ready to transmit, the PIB 112 reads it from the FIFO and begins sending it out on TR_DATA. It is sent in 4-bit increments starting at the LSB's. In a valid trace word, the 4 LSB's are never all zero, so a probe listening on the TR_DATA port can easily determine when the transmission begins and then count 15 additional cycles to collect the whole 64-bit word. Between valid transmissions, TR_DATA is held at zero and TR_CLK continues to run. TR_CLK runs continuously whenever a probe is connected. An optional signal TR_PROBE_N may be pulled high when a probe is not connected and could be used to disable the off-chip trace port. If not present, this signal must be tied low at the PIB input.

The following encoding is used for the 6 tag bits in each trace word. As discussed above, the four least-significant bits in the encoded field are non-zero to tell the PIB receiver that a valid transmission is starting:

// if (srcount == 0), EncodedSrCount = 111000 = 56
// else if srcount == 16) EncodedSrCount = 111001 = 57
// else if (srcount == 32) EncodedSrCount = 111010 = 58
// else EncodedSrcount = srcount

The invention supports breakpoint-based enabling of tracing. Each hardware breakpoint in the EJTAG block has a control bit associated with it that enables a trigger signal to be generated on a break match condition. This trigger signal can be used to turn trace on or off, thus allowing a user to control the trace on/off functionality using breakpoints. For the simple hardware breakpoints, there are already defined registers TraceIBPC, TraceDBPC, etc. in PDtrace that are used to control tracing functionality. Similar registers need to be defined to control the start and stop of trace information. In addition, the new complex Tuple breakpoints need to be added to the list of breakpoints that can trigger trace. The details on the actual register names and drseg addresses are shown in Table III.

TABLE III
Registers that Enable/Disable Trace from Complex Triggers
and their drseg Addresses

| | drseg | Reset | |
|---|---|---|---|
| Register Name | Address | Value | Description |
| ITrigiFlow/TrcEn | 0x3FD0 | 0 | Instruction break Trigger |
| | | | IFlowTrace Enable register |
| DTrigiFlow/TrcEn | 0x3FD8 | 0 | Data break Trigger |
| | | | IFlowTrace Enable register |
| TTrigiFlow/TrcEn | 0x3FB0 | 0 | Complex break Tuple |
| | | | Trigger IFlowTrace Enable |
| | | | register |

The bits in each register are defined as follows:
Bit 28 (IE/DE/TE): Used to specify whether the trigger signal from EJTAG simple or complex instruction (data or tuple) break should trigger IFlowTrace tracing functions or not. Value of 0 disables trigger signals from EJTAG instruction breaks and 1 enables triggers for the same.
Bits 14.0 (IBrk/DBrk/TBrk): Used to explicitly specify which instruction (data or tuple) breaks enable or disable IFlowTrace. A value of 0 implies that trace is turned off (unconditional trace stop) and a value of 1 specifies that the trigger enables trace (unconditional trace start).

While various embodiments of the invention have been described above, it should be understood that they have been presented by way of example, and not limitation. It will be apparent to persons skilled in the relevant computer arts that various changes in form and detail can be made therein without departing from the scope of the invention. For example, in addition to using hardware (e.g., within or coupled to a Central Processing Unit (“CPU”), microprocessor, microcontroller, digital signal processor, processor core, System on chip (“SOC”), or any other device), implementations may also be embodied in software (e.g., computer readable code, program code, and/or instructions disposed in any form, such as source, object or machine language) disposed, for example, in a computer usable (e.g., readable) medium configured to store the software. Such software can enable, for example, the function, fabrication, modeling, simulation, description and/or testing of the apparatus and methods described herein. For example, this can be accomplished through the use of general programming languages (e.g., C, C++), hardware description languages (HDL) including Verilog HDL, VHDL, and so on, or other available programs. Such software can be disposed in any known computer usable medium such as semiconductor, magnetic disk, or optical disc (e.g., CD-ROM, DVD-ROM, etc.). The software can also be disposed as a computer data signal embodied in a computer usable (e.g., readable) transmission medium (e.g., carrier wave or any other medium including digital, optical, or analog-based medium). Embodiments of the present invention may include methods of providing the apparatus described herein by providing software describing the apparatus and subsequently transmitting the software as a computer data signal over a communication network including the Internet and intranets.

It is understood that the apparatus and method described herein may be included in a semiconductor intellectual property core, such as a microprocessor core (eggs, embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A method of tracing processor instructions, comprising:
characterizing processor state changes in accordance with simplified instruction state descriptors; and
tracing simplified instruction state descriptors.

2. The method of claim 1 wherein the simplified instruction state descriptors are operative to reduce traced information.

3. The method of claim 1 wherein the simplified instruction state descriptors include a no instruction executed in this cycle descriptor.

4. The method of claim 1 wherein the simplified instruction state descriptors include a sequential instruction executed in this cycle descriptor.

5. The method of claim 1 wherein the simplified instruction state descriptors include a branch executed, destination predictable cycle descriptor.

6. The method of claim 1 wherein the simplified instruction state descriptors include a discontinuous instruction executed, program counter offset is small cycle descriptor.

7. The method of claim 1 wherein the simplified instruction state descriptors include a discontinuous instruction executed, program counter offset is large cycle descriptor.

8. The method of claim 1 wherein the simplified instruction state descriptors include a discontinuous instruction cycle descriptor.

9. The method of claim 1 wherein the simplified instruction state descriptors include an internal overflow cycle descriptor.

10. The method of claim 1 further comprising selectively delivering program counter information with sub-sets of simplified instruction state descriptors.

11. The method of claim 1 further comprising combining simplified instruction state descriptors with a program memory image to provide complete execution state history.

12. A computer readable storage medium storing executable instructions to characterize a circuit, comprising executable instructions to:
characterize processor state changes in accordance with simplified instruction state descriptors; and
deliver simplified instruction state descriptors.

13. The computer readable storage medium of claim 12 further comprising executable instructions to process a trace on signal.

14. The computer readable storage medium of claim 12 further comprising executable instructions to generate a no instruction executed in this cycle signal.

15. The computer readable storage medium of claim 12 further comprising executable instructions to process a stall signal.

16. A processor, comprising:
circuitry to characterize processor state changes in accordance with simplified instruction state descriptors; and
a port to route simplified instruction state descriptors.

17. The processor of claim 16 further comprising circuitry to process a trace on signal.

18. The processor of claim 16 further comprising circuitry to generate a no instruction executed in this cycle signal.

19. The processor of claim 16 further comprising circuitry to process a stall signal.

20. The processor of claim 16, wherein the processor is embodied in hardware description language software.

21. The processor of claim 16, wherein the processor is embodied in one of Verilog hardware description language software and VHDL hardware description language software.

22. A system, comprising:
a processor with
circuitry to characterize processor state changes in accordance with simplified instruction state descriptors, and
a port to route simplified instruction state descriptors; and
an instruction trace control block to route the simplified instruction state descriptors to a memory.

23. The system of claim 22 wherein the instruction trace control block routes a trace on signal to the processor.

24. The system of claim 22 wherein the instruction trace control block generates a stall signal for application to the processor.

25. The system of claim 22 further comprising FIFO control circuitry connected to the instruction trace control block.

26. The system of claim 25 further comprising a probe interface block connected to the FIFO control circuitry and the memory.

27. The system of claim 26 wherein the instruction trace control block, the memory, the FIFO control circuitry and the probe interface block form a probe.

28. A probe, comprising:
a memory;
an instruction trace control block to write simplified instruction state descriptors to the memory and selectively deliver program counter information with sub-sets of simplified instruction state descriptors.

29. The probe of claim 28 wherein the instruction trace control block processes a trace on signal.

30. The probe of claim 28 wherein the instruction trace control block generates a stall signal.

31. The probe of claim 28 further comprising a FIFO control circuit connected to the instruction trace control block.

32. The probe of claim 31 further comprising a probe interface block connected to the memory and the FIFO control circuit.
